(19) United States
(12) Patent Application Publication
(10) Pub. No.: US 2012/0077167 A1
(43) Pub. Date: Mar. 29, 2012

(54) Multi-Unit Interactive Dual-Video Medical Education System

(76) Inventor: Yvonne Weideman, Gibsonia, PA (US)

(21) Appl. No.: 13/241,963

(22) Filed: Sep. 23, 2011

Related U.S. Application Data
(60) Provisional application No. 61/404,089, filed on Sep. 27, 2010.

(51) Int. Cl. G09B 23/28

(52) U.S. Cl. 434/262

(57) ABSTRACT

The present invention is a multi-unit medical education module that includes at least two units per module. Each unit includes at least two separate videos, with one video being topical to the unit and having a length of under twenty minutes, and with the other video being a live-action interview between a health care provider and a patient (or actors representing same). The student interacts with each unit via computer and progresses to each successive unit only upon successful completion of a post-test for each unit or by individualized intervention by the supervising educator.

### CROSS-REFERENCE TO RELATED APPLICATIONS

This patent application claims priority to, and incorporates by reference, U.S. Provisional patent application Ser. No. 61/404,089 filed 27 Sep. 2010.

### BACKGROUND OF THE INVENTION

1. Field of the Invention

A multi-unit interactive dual-video medical education system simultaneously provides medical instruction and also medical practice modeling (role modeling, interview modeling) in a uniquely effective and very particular computer-interactive teaching method.

2. Description of Related Art

While communications technology has allowed for improvements in the admittedly brute force “Watch One; Do One; Teach One” approach to medical education for health care providers, there are still inherent difficulties in patient-interactive medical education at this writing. In the context of nursing education, for example, where research indicates that nurses today are undereducated for the demands of their profession, the continued use of traditional methods for training and education only contributes to the problem. Continued reliance on traditional methods despite their inadequacy may be attributable to the comfort level nurse educators have in traditional pedagogies that emphasize the teacher and the teaching, not the student. These ostensibly tried and true methods entail repetition, memorization, and recitation of standard data sets with the student as a passive recipient of the teacher's knowledge. The apparent assumption is that if the content is “covered” by the teacher, the student will learn it and be capable of applying it. However, while these approaches may lead to an increase in content knowledge, they do not by any means necessarily lead to the practitioner's being able to apply the knowledge to real life situations to advance the care of a patient. To the extent this challenge applies to nursing students the challenge is as great or greater for physicians of all types, who must become facile and conversant with ever-expanded knowledge bases and still be able to assess and diagnose—and interview a patient correctly and effectively—in real time “on the spot.”

Not incidentally, the trend in recent years—as content knowledge amounts have mushroomed—is a notable deterioration of health care provider bedside manner. Bedside manner is not just a nicety or a matter of etiquette. Good bedside manner for a health care provider: greatly increases the effectiveness of the patient interview; substantially increases patient compliance with procedures and medications; and quantifiably improves the patient's psychological well-being in a way that any health care provider will admit is important in the overall wellness in or recuperation of the patient. However, when a health care provider must both think on his or her feet and also extemporize patient interviews which have never been modeled or outlined in advance in a meaningful and memorable way, it can take an unacceptable number of years to synthesize content learning and patient interviews if workplace experience is the primary or only synthesis available.

Historically, the application of content knowledge was reserved for the clinical practicum experience, which has been understood literally for centuries as a key component of traditional health care provider education. However, today's higher patient acuity and shorter patient stays, coupled with recent growth in student enrollments, have led to a scarcity of acute care clinical sites. Moreover, although clinical practicum has been the traditional venue for application of content knowledge, mere tradition does not make clinical practicum the BEST initial application experience for a student health care provider. In fact, clinical practicum is in some ways the worst initial application for student knowledge because of the inevitable outliers typical in each patient's fact collection vis a vis the state (i.e., pregnancy), disease or syndrome as it is most typically understood. In other words, in an ideal educational setting a health care provider learns the “middle of the bell curve” symptoms and aspects of any given patient state before having to deal with the uniquenesses and quirks inevitably attributable to any given patient. By trying to learn generalities by examining and treating individual patients early on in medical education, often the student cannot see the forest for the trees, that is, incorrectly ascribes as general symptoms of a medical condition one or more particular symptoms unique to the patient and unrelated to the medical condition per se.

Although electronic communications have been incorporated into the practice of medicine, up until now certainly particularly powerful training and teaching tools—made possible by video and computer technology--have not been combined in medical education in ways that give particularly effective or improved content learning or behavior modeling. This is unfortunate, because considering the current massive medical content learning required, health care providers would really benefit by exposure to the most advanced teaching techniques possible. The days when students of nursing or medicine predominantly sit in lecture halls and listen to a single individual talk at length urgently need to give way to more advanced and effective educational methods. A need thus remains for a medical education system which provides memorable initial training for health care providers and which incorporates the appropriate and effective combination of all that is available in terms of technology-based computer interactive learning techniques and resources.

### SUMMARY OF THE INVENTION

In order to meet this need, the present invention is a method of comprehensive, multi-unit medical education via a multi-unit module (using a computer having an output device), which includes: a) optionally administering an online pre-test to a student; b) providing a unit of medical education to said student, said unit containing at least i) one topical video clip of limited time length, preferably under 20 minutes, more preferably under 10 minutes; ii) a live-action video including interview dialogue between at least one health care provider character and at least one patient character identified by name, and (iii) an optional online text teaching component corresponding to said video clip and said live-action video; and c) administering a post-test to said student, wherein if the student scores at least 80% (that is, a predetermined acceptable grade of any given percentage as determined by the system or instructor) on said post test the student automatically gains access to a next successive unit or, if the student scores less than the acceptable grade on said post test, the student is automatically directed to repeat said unit or, if the student scores less than the acceptable grade on the post test for a second time, the student is then automatically directed to a review rationale with the correct answers; and further wherein the comprehensive, multi-unit medical education method via a module contains at least two units, preferably contains at least three units and more preferably contains five to ten units. Preferably the patient character identified by name is the same character represented, by same name, in many of, and most preferably in all of, the units in the module. Finally, each module may optionally include a venue for discussion via wikkis, discussion boards, wimba or any other interactive distance learning forum.

### DETAILED DESCRIPTION OF THE INVENTION

As described immediately above, the present invention is a method of comprehensive, multi-unit medical education via a multi-unit module, which includes: a) optionally administering an online pre-test to a student; b) providing a unit of medical education to the student, said unit containing at least i) one topical video clip of limited time length, preferably under 20 minutes, more preferably under 10 minutes; ii) a live-action video including interview dialogue between at least one health care provider character and at least one patient character identified by name, and (iii) an optional online text teaching component corresponding to said video clip and said live-action video; and c) administering a post-test to the student, wherein if the student scores at least 80% (that is, a predetermined acceptable grade of any given percentage as determined by the system or instructor) on the post test the student automatically gains access to a next successive unit or, if the student scores less than the acceptable grade on the post test, the student is automatically directed to repeat the unit or, if the student scores less than the acceptable grade on the post test for a second time, the student is then automatically directed to a review rationale with the correct answers; and further wherein the comprehensive, multi-unit medical education method via a module contains at least two, more preferably three and even more preferably five to ten or more units per module. Preferably the patient identified by name is the same in many of, and most preferably in all of, the units in the module. The health care provider character may or may not be identified by name. In certain instances it is advantageous for the topical video clip to have a maximum five minutes' length. Finally, each module may optionally include a venue for discussion via wikkis, discussion boards, wimba or any other interactive distance learning forum.

The organization of the present medical education system into multi-unit modules, with “multi-unit” meaning at least two but preferably three or more and most preferably 5-10 or more units per module, acknowledges that human learning is limited both by content absorption capability per session and also the physiological exigencies of attention span measured by time. Professional presenters in all fields acknowledge that an audience needs a “bang,” or an attention-getter, at least once every eleven minutes. The present invention improves even on this traditional presentation approach by requiring at least two different videos per unit with one of the video's being a topical video of preferably less than 20 minutes in length, more preferably less then 10 minutes in length, and the other being (or containing) live-action conversation. While the overall length of the unit can vary, therefore, without limitation it will generally be the case that a single unit within the present invention will be a learning unit that the student will complete in approximately one hour (more or less depending on student preference). However, regardless of the length or content of the videos or other materials in the unit, if any, or the time the student elects to use to complete the unit, the inclusion of two separate videos, with one of under twenty minutes' in length, provides a unique psychological variation that gives new and unexpectedly improved learning in the student experiencing it.

The pre-test aspect of the present invention is optional, but does form a part of the preferred implementation of the invention. Especially in the context of receiving variously styled sensory input in each unit of the invention, the pre-test sets the context in which the content learning will take place, because the student has already self-assessed areas and developed curiosity and motivation to learn the content of the unit.

In one embodiment of the present invention, the multi-unit interactive dual-video medical education system of the present invention is a Pregnancy Nursing module that includes nine (9) units. Each of the nine units is designed to cover each of the nine (approximate) months of a typical pregnancy, but in an education setting the nine units are typically covered in nine weeks instead of nine months. The time span of the education using the module may of course vary depending on the educational context—a program covering a nine-month medical event could at least in theory be experienced over nine days or nine hours instead of nine weeks, say. Having said that, however, part of the benefit of presenting the instant module in units is to give the student's brain and thought processes some refraction time between units, for recollection and processing without time pressure, to maximize understanding and retention of the material. In this way the present medical modules represent learning by immersion, as the presentation of the content incorporates the materials and the skills into the student's medical education and everyday life. The use of two different videos per unit, for example, provides conversational material for the student to work into social or quasi-professional conversations or even just later reflection, when learning and understanding are cemented. Preferably, therefore, in the practice of the invention a student will not complete more than one unit of a module in any given day, and more preferably will not complete more than one unit of a module in any given week, although multiple modules on multiple topics or subjects may be conducted or experienced simultaneously.

Further in description of the above-mentioned Pregnancy Nursing module, the short (under five minute) videos in each unit are devoted to pregnancy related topics such as embryo or fetus development during the month corresponding to the unit; images or videos of ultrasound images of fetal development including possibly real-time ultrasound videos showing the fetal images and the mother's or parents' reactions; or video clips on applicable science topics such as (as a nonlimiting example) the Maternal Serum Alpha Fetoprotein (MSAFP) prenatal test (how it is administered; how the results are determined and reported; and how a patient is counseled either to have the test or to rely on the results), depending on the applicable medical education germane to the month of the pregnancy. For a first unit in a Pregnancy Nursing module, appropriate content includes a short video on fertilization and early embryonic development, for instance, or depicting the early signs of pregnancy. The separate patient-interview video in the first unit may highlight: techniques to discuss suspicion or possibility of pregnancy; compliance with or interpretation of a home pregnancy test; or a myriad of other basic aspects of pregnancy nursing having first-month relevance. Because at least one video contains live-action health care provider and patient dialogue (interview or examination modeling) while also making the patient a character known by name and appearing in most or all subsequent units in the module, the student is able to relate to the character as an actual (albeit probably hypothetical) patient who has a personality and temperament—in addition to a medical history and progression. When the nursing student begins to get to know the named pregnancy patient and to follow her thoughout her pregnancy, the named patient and her experiences provide another context for learning of the applicable pregnancy nursing material so that the nurse is prepared to interact with real pregnancy patients much sooner than the nurse would have been given teacher lecture preparation with sporadic clinical experiences with different one-time patient interactions only. With each unit's incorporating a patient character known by name, the student begins reflexively to think in terms of interacting not only as to the medical material but also in consonance with the patient's temperament, personality and evinced emotions of the moment, so that the nursing efforts are not just correct from the nurse's point of view but are accessible to the patient from the patient's point of view (“it's not what we (nurses) say, it's what they (the patients) hear”). Subsequent topics in a pregnancy module could include, without limitation, addressing gestational diabetes, insulin administration, pregnancy categories for medication and more. The dual-video approach, and the inclusion of the nurse-patient pregnancy interviews and discussions, profoundly model not only the medical content but the communications approaches necessary for successful patient interviews and care.

The present invention differs from certain online experiences or virtual worlds such as “Second Life” and others in that the videos in the units are meant to connect immediately and viscerally back to real life, real world medical situations. The invention does not seek to create nursing skills that are useful in virtual worlds for academic, research or intellectual purposes; the present module is designed to foster effective medical education for practical implementation right in the health care provider's office, hospital or any emergency flesh-and-blood venue as needed. For this reason, at least one video per unit must be live-action video among human interactors. The health care provider and patient characters may be played by actors or may indeed be real-life health care providers or patients representing themselves, but they are always live-action video to provide the credible medical education that even the best animated or computer generated characters cannot provide or model in the same way. Both the live-action and the name and character development of the patient provide the student the opportunity to relate to—even to establish an ongoing emotional connection with—the patient, to remove the education process from an impersonal memorization or rote functioning approach. While other medical educators have acknowledged the benefits in forming an emotional connection to a live-action patient (even an actor) in a medical education video, the approaches of the prior art have not combined all the components and aspects of the present multi-unit modules including the dual-video and post-test-progression of the instant invention.

By “health care provider” is meant any professional that deals with health issues or even immediate safety of a patient or accident victim. “Health care provider” for the purposes of this patent application includes, without limitation, doctors, nurses, nursing assistants, nurse practitioners, physician's assistants, medical assistants, pharmacists, physical therapists, occupational therapists, social workers, psychologists, speech therapists, other social service providers, paramedics, emergency responders, emergency medical technicians and rescue workers such as river patrol or ski patrol personnel. This broad description of “health care provider” is consistent with the applicability of the present system to instruct a wide range of health and safety modules, that is, the instant method is suitable for use by any professional or skilled volunteer who interacts or expects to interact with patients or victims for the purpose of gaining information about the patient or victim as well as counseling the patient or victim as to remedial action to be taken immediately or at a later time.

The above description of a Pregnancy Nursing module is thus exemplary of any medical education module which forms a part of this invention. Certainly a newly pregnant woman presents with behavior and physiology attributable both to condition and emotion regardless of her age or station—it is not only a young pregnant woman who might find her newly discovered condition to be overwhelming—and the emotional aspect of patient response to most or all medical conditions and concomitant health care provider interviews is ubiquitous and probably under-addressed at this writing. Certainly the conditions of, say, malignancy, valvular or vessel stenosis or aneurism, cluster headaches and migraine, and amyotrophic lateral sclerosis, just to name a few, cause terror in the patients who experience or are newly diagnosed with them. However, many medical conditions that ought not to be terrifying or even discouraging are so because the health care provider does not realize the vulnerability of the patient or is unable to avoid misunderstandings during interviews, particularly if the health care provider and the patient do not share a common first language. As a single illustrative example, consider a health care provider's possible inadvertent mischaracterization of “local anesthetic” as “general anesthesia,” understandable if the health care provider is not a native speaker of English and is trying to convey they idea of a “typical” (i.e., general) anesthetic for a simple procedure. Such a patient would likely be discouraged to learn that a simple procedure (a dental implant, say) would require general anesthesia and a period of recovery therefrom, and the patient will then either exhibit or stifle a concomitant emotional reaction to the misunderstood report without having any idea that a misunderstanding took place. Video live-action modeling of health care provider/patient interviews are able to represent both sides of the communication challenges, not only by providing outlining or scripting of the health care provider's questions but also by providing exposure to and modeled responses to a patient's reactions presented from the patient's point of view. All of this is to say that there is no area of medicine in which the present multi-unit module cannot be used for surprisingly new and improved effect in medical education, because the invention not only cements understanding of the medical material and how to present it to a patient but also how to react to the patient's perspective to discern misunderstandings or the need to address and support emotional reactions. Medical areas of education using the present module are thus limitless, and include (only by way of representation not limitation): slip-and-fall trauma diagnosis and treatment; cardiac emergency management; mental health evaluation of conditions such as attention deficit hyperactivity disorder and treatment therefor; antiviral management; neoplasm screening and assessment; adolescence issues; balloon angioplasty; barium radiography; allergy management; new baby care; endocrinology management; arthroscopy; menopause management; and many more. The present module can be used in literally any of the multitudes of medical education categories known in any system of medical intervention, including allopathic, ayurvedic, homeopathic or any other approach to wellness or disease management known now, in history or in the future. Having said that, however, the present medical module approach to medical education is best suited for—that is, the most preferred embodiments of the invention are—for medical wellness education: pregnancy, new baby care, child development assessment; adolescence physical and mental hygiene, and countless other wellness initiatives. In fact, when the health care provider is best educated and most adept at well-patient care, there is no question that disease and syndrome incidence is reduced in the patients thus cared for, often dramatically. Early pregnancy wellness initiatives; early child health actions including appropriate vaccination and nutrition; health fostering interventions regarding smoking, obesity, occupational hazard exposure and much more—all of these positive wellness initiatives have a profound benefit to patients and always represent the best efforts of any health care provider who is in a position to provide them.

As a final illustration of the Pregnancy Nursing embodiment of the invention, then, as paradigm of a wellness module according to the present invention, a unit may be presented via a computer having a user interface (including at least one output device) as follows. After (1) an optional pre-test, (2) the unit identifies in short text paragraphs (part of an interactive computer-based program governed by software and interfaced by a visual screen, text-reading computer-generated voice audible through an audio speaker, or other output device without limitation) the key educational categories of the unit (i.e., providing appropriate patient education regarding home pregnancy testing; identifying key phrases in fetal development in the first month of pregnancy; etc.) followed by (3) a content page. A typical content page includes an optional document or documents link to a textual (or audio readable) component which when present ideally contains both text/prose and illustrations/photographs, and also a link to the short (under five minute) video for the unit. The text/prose/illustrations/photographs component(s) and video link(s) are ideally of the “click to launch” type and may be marked as such for easy use. The content page is preferably preserved on the output device so that the user can download either the optional text or the short video multiple times, if desired, or save them to an electronic storage medium, before proceeding to the next phase of the unit. Overall, the student usually navigates among the phases or steps of each unit with forward or back arrows typical of web browsers at this writing, but any sort of computer interface “forward” or “back” indication is suitable for use with the output device of the present units. Fourth, the student proceeds to the patient interview video between at least one patient character and at least one health care provider character. The health care provider character may or may not be presented by name but the patient is always known by name, and will retain the same name and character throughout any successive unit in the module in which he or she appears (with the same named patient character most preferably appearing in all units of the module). Fifth, the student receives the post-unit examination, and is automatically scored as to the results of the post-unit test. If the student receives an acceptable grade on the examination—typically 80%—the student is automatically allowed to progress to the next unit in the module. If the student scores less than the acceptable grade on the post test, the student is automatically directed to repeat the unit or, if the student scores less than the acceptable grade on the post test for a second time, the student is then automatically directed to a review rationale with the correct answers. Customized student/educator interactions, if any, will inevitably be specific to the situation, and may without limitation address cognitive challenges the student may be experiencing; inadequate course background in the student prior to enrolling in the module; a need for specific tutoring or other complementary instruction or materials, etc. At no time is the student ever prevented from repeating units in the module; the progression to successive units, only, is governed by achievement of adequate post-test scores per unit or participating in the review rationale with the correct answers.

More preferably, the live-action interview video is presented in the unit second in time to the short (under twenty minute, preferably under ten minute, possibly under five minute) video. However, the present invention embraces the presentation of the (at least) two videos in either order.

Implementing the above system may be accomplished with basic and underlying distance and online learning tools available as of the priority date hereof These include without limitation the recording and posting of videos to YouTube or similar online services; the posting of educational materials to “Blackboard” type software and similar software used by colleges, universities and other educational institutions to share classroom materials; and wikki and wimba, to mention only a few. Connecting the combined inventive features described above via software and hardware is well within the skill of the art, such as providing automatic post-test scoring which allows a student to proceed to a successive module. The invention inheres in the novel and nonobvious combination of multiple components of the invention as described; those skilled in the art know the tactics for combining such components after having learned the strategic combination of components in this patent specification.

Although the invention has been described above with particularity, in reference to certain specific embodiments of the invention, the invention is only to be limited insofar as is set forth in the accompanying claims.

In the claims:

1. A method of multi-unit medical education via a multi-unit module displayed and governed by a computer having an output to a user, comprising: a) optionally administering to a user as governed by said computer an online-pre-test; b) providing a unit of medical education via computer to said user, said unit being in computer-user interactive form and containing at least i) one topical medical education video clip of limited time length; ii) a live-action video including interview dialogue between at least one health care provider character and at least one patient character identified by name; and iii) an optional online text teaching component corresponding to either of said video clip of under five minutes in length or said live-action video; and c) administering a post-test specific to the unit to the user after the user reads and views the materials of the unit.

2. The method according to claim 1, wherein said computer governs the administration of said post-test, scores said post-test and further directs the availability of access by said user to any subsequent unit as determined by the grade scored by said user on said post-test.

3. The method according to claim 1, wherein said computer governs the administration of said post-test, scores said post-test and further directs the availability of access by said user to any subsequent unit by either allowing a first user who scored a pre-determined minimum score on the post-test to advance to a next consecutive or subsequent unit or by automatically screening a second user who scores less than said pre-set minimum score on the post-test and prompting such second user either to repeat the unit or to participate in a review rationale presenting the correct answers to the post-test questions.

4. The method according to claim 1 wherein as a first step in the method the user takes a pre-test and the computer scores the pre-test and reports the test score and correct answers to the user.

5. The method according to claim 1 wherein said multi-unit modules number at least five consecutive modules.

6. The method according to claim 1 wherein said multi-unit modules number at least ten consecutive modules.

7. The method according to claim 1 wherein said at least one patient character appears in at least two modules and has and is audibly called by the same name in at least two modules.

8. The method according to claim 7 wherein said at least one patient character appears in all modules and has and is audibly called by the same name in all modules.

9. The method according to claim 1 wherein said health care provider character appears in at least two modules and has and is audibly called by the same name in at least two modules.

10. The method according to claim 1 wherein said online text teaching component topically corresponds to both the topic of said video clip of under ten minutes in length and the topic of said live-action video.
